(19) United States
(12) Patent Application Publication
(10) Pub. No.: US 2015/0090905 A1
(43) Pub. Date: Apr. 2, 2015

(54) Micromagnet Based Extreme Ultra-Violet Radiation Source

(71) Applicants: Dmitri E. Nikonov, Beaverton, OR (US); Ian Young, Portland, OR (US)

(72) Inventors: Dmitri E. Nikonov, Beaverton, OR (US); Ian Young, Portland, OR (US)

(21) Appl. No.: 14/039,603

(22) Filed: Sep. 27, 2013

(51) Int. Cl. H05G 2/00

(52) U.S. Cl. CPC H05G 2/00
USPC 250/504 R

(57) ABSTRACT

An embodiment includes a magnetic wiggler comprising: first and second magnets adjacent each other in a line of at least 50 magnets; a pathway, adjacent to the line, along which an electron beam may travel that is to couple to a particle accelerator; and a plurality of vias on multiple sides of each of the first and second magnets to provide multiple currents, having opposite directions, respectively to the first and second magnets to orient the first and second magnets with opposing non-volatile orientations. Other embodiments are provided herein.

### TECHNICAL FIELD

The present invention generally relates to semiconductor processing, and specifically relates to an improved Extreme Ultraviolet (EUV) illumination source.

### BACKGROUND

Integrated Circuits (ICs) generally comprise many semiconductor features, such as transistors, formed on a semiconductor substrate. The patterns used to form the devices may be defined using a process known as photolithography. Using photolithography, light is shone through a pattern on a mask, transferring the pattern to a layer of photoresist on the semiconductor substrate. The photoresist can then be developed, removing the exposed photoresist and leaving the pattern on the substrate. Various other techniques, such as ion implantation, etching, etc. can then be performed to the exposed portion of the substrate to form the individual devices.

To increase the speed of ICs such as microprocessors, more and more transistors are added to the ICs. Therefore, the size of the individual devices must be reduced. One way to reduce the size of individual features is to use short wavelength light during the photolithography process. According to Raleigh's Law (R=k*λ/NA, where k is a process dependent constant, λ is the wavelength of illumination, NA=Numerical Aperture, and R is the resolution of features), a reduction in the wavelength of the light proportionately reduces the size of printed features.

Extreme ultraviolet (EUV) light (e.g., 13.5 nm wavelength light) may be used to print very small semiconductor features. For example, EUV may be used to print isolated features that are 15-20 nanometers (nm) in length, and nested features and group structures that have 50 nm lines and spaces.

EUV photons can be generated by excited atoms of a plasma. One way to generate the plasma is to project a laser beam on to a target (droplet, filament jet) creating a highly dense plasma. When the excited atoms of the plasma return to a stable state, photons of a certain energy, and thereby a certain wavelength, are emitted. The target may be, for example, Xenon, Tin, or Lithium.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 depicts a micromagnet EUV source in an embodiment of the invention.

FIG. 2 depicts an on-chip wiggler in an embodiment of the invention.

FIG. 3 depicts current pathways for orienting micromagnets in an embodiment of the invention.

FIG. 4(a) depicts initial conditions for an electron beam before entering an embodiment of a wiggler, and FIG. 4(b) depicts conditions for the electron beam after leaving the embodiment of the wiggler.

FIG. 5 depicts current pathways for orienting micromagnets in an embodiment of the invention.

FIG. 6 depicts a portion of an on-chip wiggler in an embodiment of the invention.

FIG. 7 depicts a portion of an on-chip wiggler in an embodiment of the invention.

### DETAILED DESCRIPTION

Reference will now be made to the drawings wherein like structures may be provided with like suffix reference designations. In order to show the structures of various embodiments more clearly, the drawings included herein are diagrammatic representations of integrated circuit structures. Thus, the actual appearance of the fabricated integrated circuit structures, for example in a photomicrograph, may appear different while still incorporating the claimed structures of the illustrated embodiments. Moreover, the drawings may only show the structures useful to understand the illustrated embodiments. Additional structures known in the art may not have been included to maintain the clarity of the drawings. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

As described above, EUV photons can be produced using plasma-based technologies. However, such technologies are problematic because of the high amounts of energy and the large size of equipment needed to excite the atoms used in plasma-based methods. Furthermore, plasma based sources suffer from an undesirable maximum available output power of about 100 W of EUV.

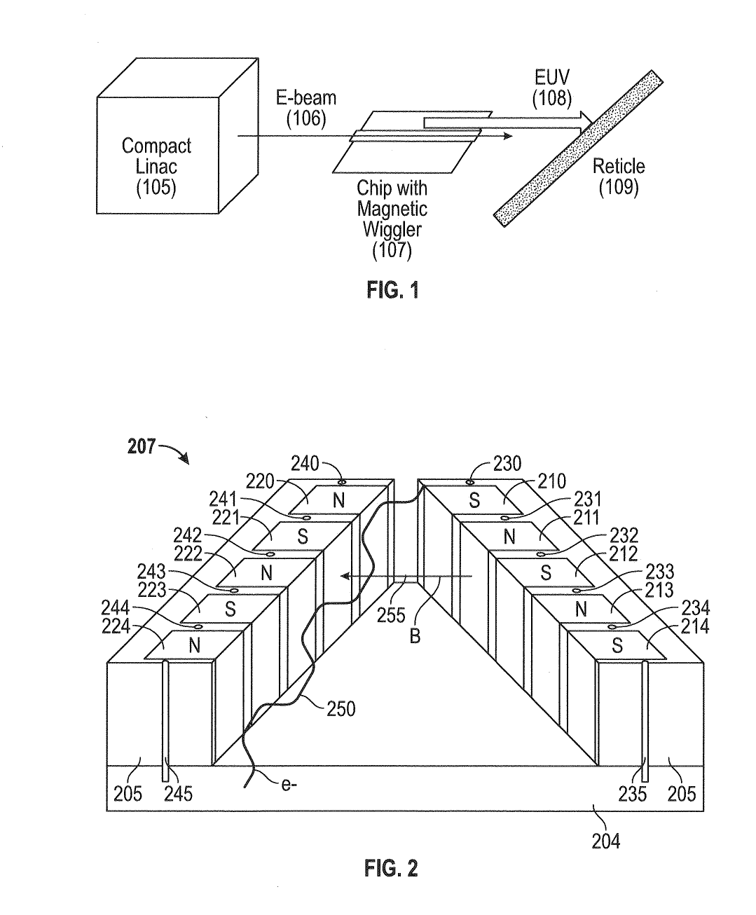

An embodiment of the invention, however, obtains a maximum available output power of about 5,000 W (or greater) of EUV. As shown in FIG. 1, such an embodiment projects a beam of free electrons 106 from a compact linear accelerator (LINAC) 105 into magnetic wiggler (i.e., undulator) 107, which in turn produces EUV 108 that is directed to reticle 109 to perform photolithography. The wiggler is able to produce the short wavelength of EUV because, for example, the wiggler is made with micro-scale magnets on a semiconductor integrated circuit (IC) chip. Consequently, the chip-based wiggler is much smaller than some of the equipment needed in plasma-based technologies and also requires less energy to operate.

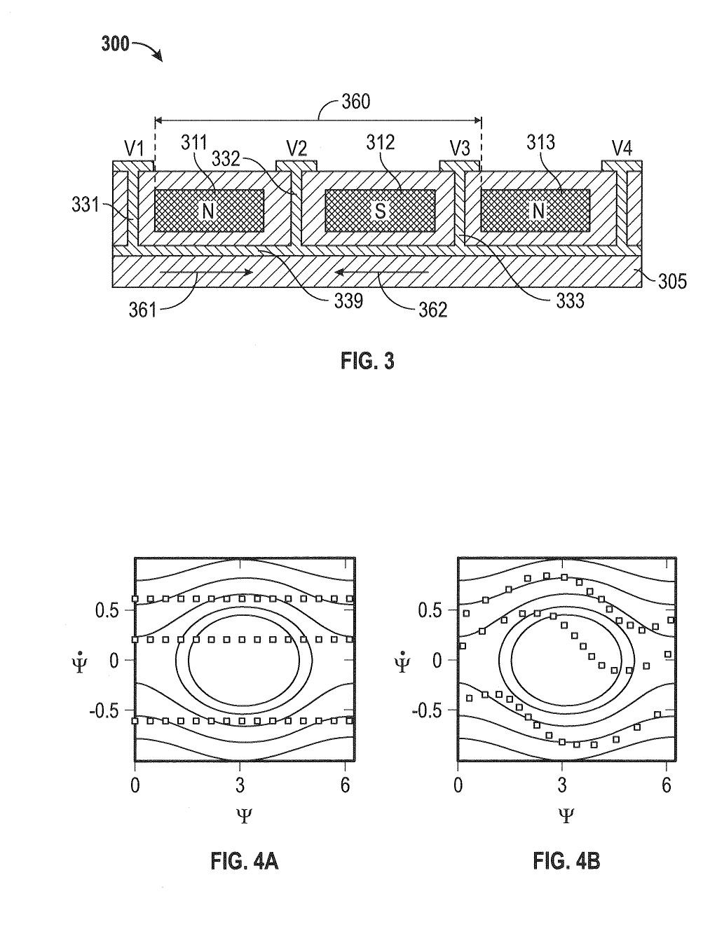

FIG. 2 depicts on-chip wiggler 207 in an embodiment of the invention. Wiggler 207 includes permanent magnets 210, 211, 212, 213, 214, 220, 221, 222, 223, 224 within oxide 205 (or other non-magnetic material) and over substrate 204. FIG. 3 depicts magnets 311 (which corresponds to magnet 211), 312 (which corresponds to magnet 212), and 313 (which corresponds to magnet 213) in greater detail. FIGS. 2 and 3 are discussed interchangeably below.

Wiggler 207 produces a spatially periodic magnetic field 255 with a period (λ_{W}). Period λ_{W} is based on magnet pitch distance 360 (i.e., the distance from the “beginning”/“end” of a “N” magnet to the “beginning”/“end” of the next “N” magnet or the distance from the “beginning”/“end” of a “S” magnet to the “beginning”/“end” of the next “S” magnet). Wiggler 207 has a number of periods (N_{w}), only some of which are shown in FIG. 2. Therefore the length of the wiggler is L_{W}=N_{W}λ_{W}. The number of periods must be large enough to act on particle beam 250 so that so that wiggler 207 transfers enough energy to form EUV beam 108. For example, each series of magnets (magnets 210, 211, 212, 213, 214 comprising a first series and magnets 220, 221, 222, 223, 224 comprising a second series) may have over 100 periods (200 magnets) to properly impose oscillation at a short wavelength on the radiated photons). The wavelength of light (λ_{L}) emitted by free electrons in the beam is related to the energy of the electrons in the beam as follows: λ_{W}=2γ²λ_{L}, where γ=1/\sqrt{1−(v/c)²}, v is the velocity of the electrons, and c is the speed of light. The energy (E) of each electron of mass (m) is E=γmc². For γ=100, the energy E is approximately 50 MeV and the wiggler period for such energy is λ_{W}=270 μm. λ_{W} is determined by the distance 360 (e.g. in an embodiment, if desired λ_{W} is 270 μm then distance 360 is 270 μm), which is quite small yet suitable for an onchip wiggler. In other words, small magnets that fit within such a small period may be implemented with deposition of magnetic materials on a chip. Thus, for a γ=100 and λ_{L} of 13.5 nm (i.e., EUV) λ_{W}=2γ²λ_{L} dictates λ_{W}=270 μm. Considering a λ_{L} of 13.5 nm is 20,000 times less than a λ_{W}=270 μm, such a λ_{W} is suitable for an on chip wiggler such as the wigglers addressed in embodiments described herein.

Electrons 250 oscillate in magnetic field 255 and emit light. For a sufficient magnetic field of the magnets 255 (B_{w}) of about 1 T, N_{w}, >100 (less than 10 periods are shown in FIG. 2 for ease of illustration and clarity). As wiggler 207 maintains the resonant condition (λ_{W}=2γ²λ_{L}), the electrons 250 can transfer as much as 10% of their energy to radiation. Thus, with current I=10 mA the energy of the beam

$$( {P}_{b} ) = \frac{γ {mc}^{2} I}{e} \approx 50 kW$$

(where e is the magnitude of the charge of an electron) and the radiated power (Pᵣ) is 10% of P_{b} such that Pᵣ=5 kW.

As the magnetic layers are deposited to form magnets 210, 211, 212, 213, 214, 220, 221, 222, 223, 224 and the like, the magnetization of these magnets will be arbitrary. Thus, the magnetic north (“N”) and south (“S”) magnetic poles shown in FIG. 2 are positioned at random immediately after fabrication. In order to set the magnetization direction, and thus the positions of the magnetic poles, in the correct, alternating sequence (N alternating with S), wiggler 207 includes current pathways (e.g., filled with Cu or Al) within vias 230, 231, 232, 233, 234, 235, 240, 241, 242, 243, 244, 245 and included in horizontal wire 339. As shown in greater detail in FIG. 3, “wires” 331, 332, 333 (which correspond to vias 231, 232, 233) and 339 provide current pathways around magnets 311, 312 (wherein “wires” as used herein are to be interpreted broadly as conductive pathways). Voltage supplied to nodes V1 and V2 may supply current in one direction 361 to impose a polarity “N” on magnet 311. Voltage supplied to nodes V2 and V3 may supply current in an opposite direction 362 to impose a polarity “S” on magnet 312. While not shown in FIG. 3, nodes V1, V2, V3, V4 and the like may couple to switches (e.g., transistors, multiplexors, and the like) to control current paths to properly direct current to specific desired magnets (and avoid sending current to other undesired magnets). For example, through turning on one or more transistors and turning off one or more transistors current may be sent between nodes V1 and V2 but no current is sent to nodes V3 or V4.

Thus, an embodiment includes first, second, and third magnets immediately adjacent one another in a first line (such as magnets 211, 212, 213 and the like), and additional magnets in a second line (such as magnets 221,222, 223 and the like). A pathway along which an electron beam (i.e., electrons) may travel is located between the first and second lines. A first via, such as via 332, is between magnets 311, 312 and is to pass current that provides a first magnetic field, having a first orientation (e.g., a “N” orientation), to the first magnet. A second via 333 adjacent magnet 312 is to pass current that provides a second magnetic field, having a second orientation (e.g., an “S” orientation) opposite the first orientation, to the second magnet. As a result, magnet 311 is an “N” magnet and its immediately adjacent magnet 312 is an “S” magnet. The “N” and “S” magnet orientations are “non-volatile” in that they retain their orientations after power is no longer supplied to the chip upon which they reside.

In comparison with conventional EUV sources, an embodiment obtains a higher EUV power (up to 5,000 W or more vs. 100 W) and requires less power (˜50 kW vs. 200 kW) than is necessary for a CO₂ laser. In comparison with conventional free electron lasers, an embodiment provides light with a much shorter wavelength (e.g., 13.5 nm vs. ˜1,000 nm). Further, the embodiment is much more compact than conventional systems. For example, system 100 may use a commercially available compact LINAC instead of a large synchrotron accelerator. Further, the embodiment uses an on-chip magnetic wiggler (a few cm in size) rather than a discrete magnet wiggler (a few meters in size).

Regarding the advanced EUV power discussed above, the strength of the wiggler and light fields are expressed through their vector potentials, A_{W} of the wiggler and A_{L} of light, respectively, and dimensionless vector potentials, a_{W} and a_{L}. They are in turn expressed via the magnetic field B_{W} of the wiggler through:

$${a}_{W} = \frac{{eA}_{W}}{mc \sqrt{2}} = \frac{{eB}_{W}}{{k}_{W} mc \sqrt{2}}$$

with k_{W}=2π/λ_{W} being the wavenumber for the wiggler; and

$${a}_{L} = \frac{{eA}_{L}}{mc \sqrt{2}}$$

is expressed via the light power (P) which, in one embodiment discussed above, is 5 kW to generate EUV wavelength radiation. The light power P=Sc∈E_{L}², where ∈ is the dielectric constant, EUV beam spot size (S)=1 μm×1 μm, (E_{L})=electric field in the light wave: E_{L}=λ_{L}A_{L}/c. The rate of evolution of the phase of electrons in the wiggler is Nᵣₒₜ=4a_{w}a_{L}k_{L}c/γ where k_{L}=2π/λ_{L} is the wavenumber of the EUV light. The conversion factor from velocity of electrons to their phase relative to the light wave is

$${P}_{conv} = \frac{{k}_{L} c}{{γ}^{3}} .$$

The condition for sufficient extraction of energy from electrons (corresponding to trajectories below) is NᵣₒₜP_{conv}L_{W}²/c²˜π² and is fulfilled for the parameters used in the calculation. In other words, the above shows an embodiment is able to produce EUV with the proper wavelength and power.

FIG. 4(a) depicts electron trajectories in the free-electron laser where the horizontal axis concerns phase for the electrons related to their position relative to the light wave and the vertical axis is the time derivative of the phase related to the energy of the electrons. FIG. 4(a) depicts initial conditions for an electron beam before entering an embodiment of a wiggler for three selected values of their energy. Their phase is uniformly distributed between 0 and 2π, because electrons enter the wiggler at random positions relative to the light wave. FIG. 4(b) depicts conditions for the electron beam at the same three values of energy after leaving the embodiment of the wiggler (after undulator/wiggler has imposed resonance at EUV wavelength on the particle). These graphs illustrate that electrons exit with, on the average, more negative derivative of the phase, and therefore smaller energy, than the energy with which they enter. This corresponds to the electron beam transferring a significant fraction of its energy to the light wave.

Thus, embodiments have several advantages over conventional systems. For example, and as noted above, an embodiment of the magnetic wiggler has a size which is orders of magnitude smaller than conventional sources and the wiggler is implemented as a solid state structure containing micromagnets. The radiated light wavelength is orders of magnitude shorter than with conventional wiggler sources. Also, the radiated EUV is obtained mostly by spontaneous emission, compared to a smaller probability of stimulated emission. In an embodiment this results in only partially coherent light that is desirable for improvement of lithography resolution. Such an embodiment enables EUV lithography and is likely to not be limited by output power (and therefore may be preferable to other lithography methods).

A example includes an apparatus comprising: first, second, and third magnets immediately adjacent one another in a first line, and additional magnets in a second line; a pathway along which an electron beam can travel, the pathway located between the first and second lines, arranged to couple to a particle accelerator; a first via between the first and second magnets to pass current that provides a first magnetic field, having a first orientation, to the first magnet; and a second via adjacent the second magnet to pass current that provides a second magnetic field, having a second orientation opposite the first orientation, to the second magnet.

Such an apparatus may comprise a magnetic wiggler or undulator. The vias may be filled with Cu, Al, Au and the like. The first via may pass first current in a first direction that provides the first magnetic field with its first orientation (e.g., pole “S” towards the viewer) dictated by the “right hand rule”. The second via may pass second current traveling in a second direction, which is the opposite of the first direction. This second current, also following the right hand rule, will impose the second magnetic field, having a second orientation (e.g., pole “N” towards the viewer) opposite the first orientation, to the second magnet.

The first, second, and third magnets “immediately adjacent” one another may simply include three magnets sequentially arranged such as magnets 211, 212, 213. They do not necessarily directly contact each other and may be separated by oxide or another non-magnetic material and the like. In an embodiment there are no other magnets interposed between any of the first, second, and third magnets (such as the case is with magnets 211, 212, 213). For example, in an embodiment the second magnet is between the first and third magnets and no other magnets are between the first and third magnets.

In another example the subject matter of the example or subsequently mentioned examples can optionally include wherein the first magnet has the first orientation based on the first magnetic field and the second magnet has the second orientation based on the second magnetic field and the first and second orientations are non-volatile.

For example, the passing of the above current in proximity to the magnets (i.e., close enough so that generated magnetic field affects the magnet's orientation) generates magnetic fields (that have directed orientations) on the magnets that “program” or “orient” the magnets such that the magnets retain their orientations after the initial programming.

In another example the subject matter of the example or subsequently mentioned examples can optionally include wherein the first and second lines of magnets are included on a monolithic substrate.

Thus, the first and second series or lines of magnets may share the same chip. This same chip may include a system on a chip that also includes one or more controllers (e.g., signal processors) and may be included on the same chip as various portions of a particle accelerator, such as a LINAC.

In another example the subject matter of the example or subsequently mentioned examples can optionally include the particle accelerator. Thus, the example of above describes an embodiment that is not necessarily sold or shipped or included with a LINAC, but may be sold or shipped or included with a LINAC in other embodiments.

In another example the subject matter of the example or subsequently mentioned examples can optionally include wherein (a) the second magnet is between the first and third magnets and no other magnets are between the first and third magnets, (b) the first magnet has an outer edge opposite an inner edge and the inner edge is immediately adjacent the second magnet, (c) the third magnet has an inner edge immediately adjacent the second magnet, and (d) a distance extending from the outer edge of the first magnet to the inner edge of the third magnet is configured to produce an light beam with an extreme ultraviolet wavelength.

In another example the subject matter of the example or subsequently mentioned examples can optionally include wherein the first line of magnets includes a magnet pitch distance less than 500 microns.

For example, the first, second, and third magnets may be next to one another and a distance, such as distance 360, equates generally to magnetic pitch or λ_{W}. λ_{W} may be 270 microns but in other embodiments may be 5, 10, 20, 50, 100, 150, 200, 250, 350, 400, 500, 700 microns or more or any point in between. For example, considering λ_{W}=2γ²λ_{L}, many embodiments are possible. Specifically, a larger input power (γ) from a LINAC/source allows for larger λ_{W}. Thus, larger input powers may allow for larger magnet pitches such as 400, 500, 700, 800, 900, 1000 microns or more. This allows for “tailoring” of the SoC to the LINAC or beam source.

In another example the subject matter of the example or subsequently mentioned examples can optionally include wherein the magnet pitch distance is configured to radiate extreme ultraviolet light having a power greater than 2,500 W.

In other embodiments the magnet pitch distance is configured to radiate extreme ultraviolet light having a power greater than 400; 450; 500; 1,000; 1,500; 2,000; 3,000; 3,500; 4,000; 4,500; 5,500; 6,000 W and the like.

In another example the subject matter of the example or subsequently mentioned examples can optionally include wherein the magnet pitch distance is configured to radiate extreme ultraviolet light having a wavelength less than 300 nm.

For example, the magnet pitch distance is configured to radiate extreme ultraviolet light having a wavelength less than or equal to 10, 13.5, 35, 50, 80, 110, 150, 200, 250, 270, 299 nm and points there between.

In another example the subject matter of the example or subsequently mentioned examples can optionally include wherein the first and second lines of magnets each include more than 50 magnets and the first line of magnets is arranged with alternating magnetic orientations so adjacent magnets have opposite magnetic orientations.

In another example the subject matter of the example or subsequently mentioned examples can optionally include wherein the second line includes a fourth magnet and the first and fourth magnets are arranged as a complementary pair, the fourth magnet having a magnetic orientation opposite the first magnetic orientation.

For example, complementary pairs include magnets 210 and 220, 211 and 221, and the like. Such magnets are “opposite” one another across the pathway that electron 250 travels.

In another example the subject matter of the example or subsequently mentioned examples can optionally include wherein the first and second vias couple together to form a current pathway adjacent at least three sides of the second magnet.

For example, vias 332, 333, along with the horizontal element 339 connecting them, provide current adjacent three sides of magnet 312.

In another example the subject matter of the example or subsequently mentioned examples can optionally include wherein the first via also passes the current that provides the second magnetic field.

For example, via 332 may optionally pass current from or based on current from directions 361 and 362 (e.g., non-simultaneously in some embodiments or simultaneously in other embodiments). However, another embodiment may have two vias between the first and second magnets, with one via for current that traces three sides of the first magnet (along direction 361) and another via that traces three sides of the second magnet (along direction 362).

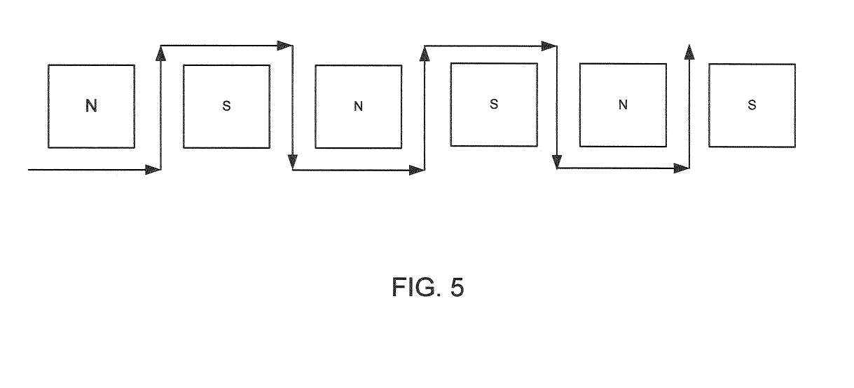

There is no one way vias must be formed or current must be communicated. For example, in an embodiment one or more magnets can each have an independent current loop. In FIG. 5 a single current path winds its way among magnets thereby alternating its “right hand rule” effect and generating alternating N and S oriented magnets

In another example the subject matter of the example or subsequently mentioned examples can optionally include a third via adjacent the first magnet, wherein the first and third vias couple together to form a current pathway adjacent at least three sides of the first magnet.

For example, via 331 and via 332 are both adjacent magnet 311.

In another example the subject matter of the example or subsequently mentioned examples can optionally include wherein the first and third vias connect to one another directly beneath the first magnet.

For example, vias 331 and 332 connect to each other via the interconnect (i.e., wire or line) 339 directly below magnet 311.

In another example the subject matter of the example or subsequently mentioned examples can optionally include wherein the second magnet is between the first and third magnets and no other magnets are between the first and third magnets.

An additional example includes a magnetic wiggler comprising: first and second magnets adjacent each other in a line of at least 50 magnets; a pathway along which an electron beam may travel, adjacent to the line, to couple to a particle accelerator; and a plurality of vias on multiple sides of each of the first and second magnets to provide multiple currents having opposite directions respectively to the first and second magnets to orient the first and second magnets with opposing non-volatile orientations.

For example, in FIG. 5 some current paths point down between two adjacent magnets while others point up between two adjacent magnets. In some embodiments a single current pathway between two magnets may deliver current in a single direction that imparts opposite magnetic orientations on two adjacent magnets the pathway is formed between. Still concerning FIG. 5, this figure depicts a winding current pathway current may flow through this pathway. The current may include a first current moving up between two magnets while, simultaneously, a second current included in the current flows down between two magnets.

In another example the subject matter of the “additional” example can optionally include a third magnet adjacent the second magnet, wherein a distance extending from an end of the first magnet to an end of the third magnet is configured to produce a light beam with an extreme ultraviolet wavelength.

In another example the subject matter of the “additional” example or subsequently mentioned examples can optionally include wherein the distance is less than 500 microns (e.g., 5, 10, 20, 50, 100, 150, 200, 250, 270 microns).

An example of a method includes providing a wiggler including (a) first, second, and third magnets immediately adjacent one another in a first line, and additional magnets in a second line; (b) a pathway, between the first and second lines along which an electron beam may travel, arranged to couple to a particle accelerator; (c) a first via between the first and second magnets; and (d) a second via adjacent the second magnet; passing first current to the first via and, based on the first current, providing a first magnetic field having a first orientation to the first magnet; and passing second current to the second via and, based on the second current, providing a second magnetic field having a second orientation, opposite the first orientation, to the second magnet.

In another example the subject matter of the method example or subsequently mentioned examples can optionally include programming the first magnet, with the first magnetic field, to have the first orientation; and programming the second magnet, with the second magnetic field, to have the second orientation.

In yet another example, an apparatus comprises: first, second, and third magnets immediately adjacent one another in a first line, and additional magnets in a second line; a pathway, between the first and second lines along which an electron beam may travel, arranged to couple to a particle accelerator; wherein the first line of magnets (a) includes a magnet pitch distance less than 1,000 microns, and (b) is arranged with alternating magnetic orientations so adjacent magnets have opposite magnetic orientations.

Thus, in some embodiments via, wires, and the like are not necessarily included. There may be various ways in various embodiments to set magnetization. For example, spin torque switching and magnetoelectric switching may be used.

In another example the subject matter of the “yet another example” may optionally include wherein the first line of magnets includes a magnet pitch distance less than 300 microns.

Regarding spin torque switching, some magnetic memories, such as a spin transfer torque memory (STTM), utilize a magnetic tunnel junction (MTJ) for switching and detection of the memory's magnetic state. A spin transfer torque random access memory (STTRAM), a form of STTM, includes a MTJ consisting of ferromagnetic (FM) layers and a tunneling barrier between the FM layers. Memory is “read” by assessing the change of resistance (e.g., tunneling magnetoresistance (TMR)) for different relative magnetizations of the FM layers. More specifically, MTJ resistance is determined by the relative magnetization directions of FM layers. When the magnetization directions between the two FM layers are anti-parallel, the MTJ is in a high resistance state. When the magnetization directions between the two FM layers are parallel, the MTJ is in a low resistance state. One FM layer is the “reference layer” or “fixed layer” because its magnetization direction is fixed. The other FM layer is the “free layer” because its magnetization direction is changed by passing a driving current polarized by the reference layer (e.g., a positive voltage applied to the fixed layer rotates the magnetization direction of the free layer opposite to that of the fixed layer and negative voltage applied to the fixed layer rotates the magnetization direction of free layer to the same direction of fixed layer).

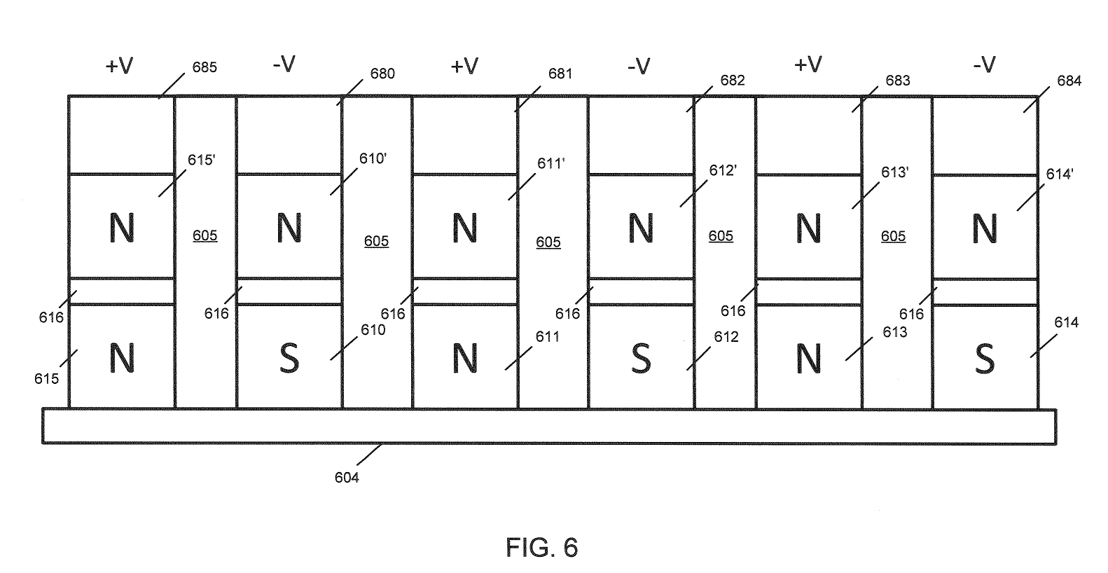

In a similar manner, FIG. 6 includes an embodiment where the magnetization of magnets 610, 611, 612, 613, 614, 615 (and similar complementary magnets in another row or line of magnets) and the like may be rotated or, more generally, set. For example, non-magnetic layer 616 (e.g., Cu) may be on magnets 610, 611, 612, 613, 614, 615 (which are within non-magnetic material 605 and on ground layer 604) and the like and a fixed FM layer may be on the non-magnetic layer. In another embodiment a series of fixed FM layers/portions of a layer 610′, 611′, 612′, 613′, 614′, 615′ (within non-magnetic material 605) may be positioned over non-magnetic layer portions 616 and respectively over magnets 610, 611, 612, 613, 614, 615 and the like. In a manner similar to changing a state in a MTJ of a STTRAM, the polarity or orientation of the free FM layers (i.e., magnets 610, 611, 612, 613, 614, 615 and the like) may be set to produce alternating N and S magnets (i.e., vary voltages to fixed layers 610′, 611′, 612′, 613′, 614′, 615′, respectively through current supplied by current pathways 680, 681, 682, 683, 684, 685, to vary orientations of magnets in the free layers). Thus, some embodiments may include one or more magnetic junctions to orient magnets in the wiggler. As shown above, various embodiments include no vias or current pathways between the free magnets or beneath the free magnets.

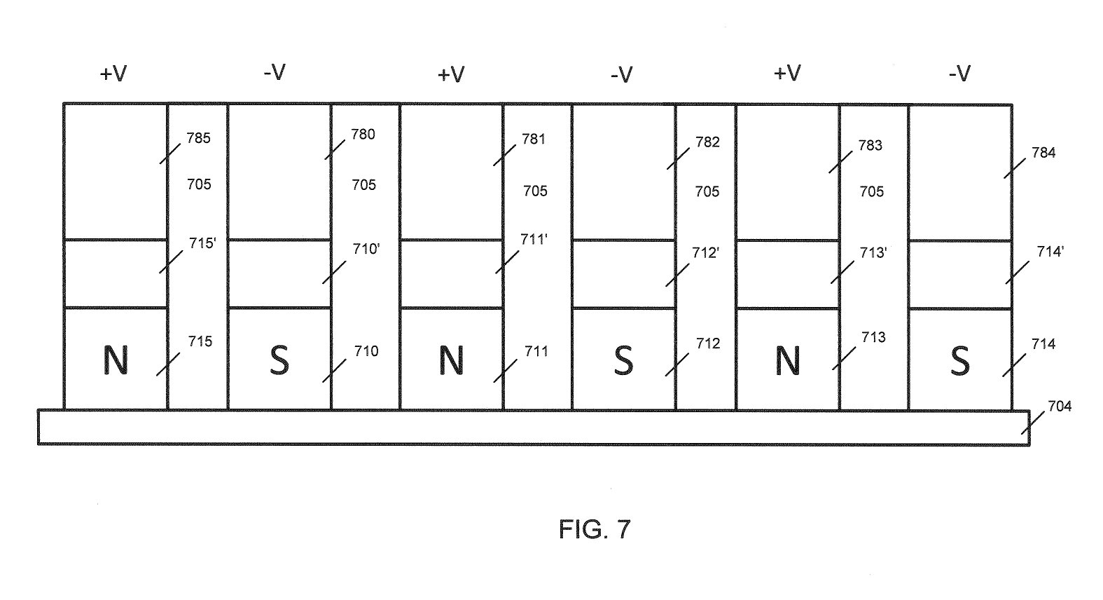

In another embodiment (FIG. 7), the magnetization can be switched by magnetoelectric effect. For example, a layer of piezoelectric material portions 710′, 711′, 712′, 713′, 714′, 715′ can be formed within non-magnetic material 705 and adjacent to ferromagnets such as magnets 710, 711, 712, 713, 714, 715 (which couple to ground layer/plane 704). In some embodiments the piezoelectric material portions directly contact the ferromagnets. As voltage is applied to the piezoelectric layer portions (through current pathway 780, 781, 782, 783, 784, 785), strain is induced in the piezoelectric layer portions. Due to the strain, the piezoelectric layer portions exert stress on the FM layer magnets, thereby changing magnetic anisotropy within the magnets. This results in alignment of magnetization to the direction of the lowest energy.

In another example the subject matter of the “yet another example” may optionally include wherein the alternating magnetic orientations are non-volatile.

In another example the subject matter of the “yet another example” or subsequent examples may optionally include wherein the first and second lines of magnets are included on a monolithic substrate.

In another example the subject matter of the “yet another example” or subsequent examples may optionally include wherein the magnet pitch distance (e.g., distance 360 that is less than 300 microns) is configured to radiate extreme ultraviolet light having a wavelength less than 300 nm (e.g., 270 nm).

In another example the subject matter of the “yet another example” may optionally include: first, second, and third fixed magnetic layer portions immediately adjacent one another and respectively over the first, second, and third magnets; and a nonmagnetic layer between the first, second, and third fixed magnetic layer portions and the first, second, and third magnets; wherein the alternating magnetic orientations are set based on corresponding alternating voltages supplied to the first, second, and third fixed magnetic layer portions.

In another example the subject matter of the “yet another example” may optionally include first, second, and third piezoelectric material portions directly contacting the first, second, and third magnets; and wherein the alternating magnetic orientations are set based on corresponding alternating voltage induced strains induced in the first, second, and third piezoelectric material portions.

As used herein a “line” need not necessarily be an entirely straight line and may be, for example, curved or undulating in some manner. For example, the magnets in a line do not necessarily need to be perfectly aligned in a straight line. Some magnets may be offset from other magnets in the same “line”.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

1. An apparatus comprising:
first, second, and third magnets immediately adjacent one another in a first line, and additional magnets in a second line;
a pathway, between the first and second lines, along which an electron beam may travel that is arranged to couple to a particle accelerator;
a first via between the first and second magnets to pass current that provides a first magnetic field, having a first orientation, to the first magnet; and
a second via adjacent the second magnet to pass current that provides a second magnetic field, having a second orientation opposite the first orientation, to the second magnet.

2. The apparatus of claim 1, wherein the first magnet has the first orientation based on the first magnetic field and the second magnet has the second orientation based on the second magnetic field and the first and second orientations are non-volatile.

3. The apparatus of claim 2, wherein the first and second lines of magnets are formed within an integrated circuit chip.

4. The apparatus of claim 2 comprising the particle accelerator.

5. The apparatus of claim 2 wherein (a) the second magnet is between the first and third magnets and no other magnets are between the first and third magnets, (b) the first magnet has an outer edge opposite an inner edge and the inner edge is immediately adjacent the second magnet, (c) the third magnet has an inner edge immediately adjacent the second magnet, (d) a distance extending from the outer edge of the first magnet to the inner edge of the third magnet is configured to produce a light beam with an extreme ultraviolet wavelength and (e) the distance is less than 500 microns.

6. The apparatus of claim 2 wherein the first line of magnets includes a magnet pitch distance less than 500 microns.

7. The apparatus of claim 6, wherein the magnet pitch distance is configured to radiate extreme ultraviolet light having a power greater than 200 W.

8. The apparatus of claim 6, wherein the magnet pitch distance is configured to radiate extreme ultraviolet light having a wavelength less than 300 nm.

9. The apparatus of claim 2 wherein the first and second lines of magnets each include more than 50 magnets and the first line of magnets is arranged with alternating magnetic orientations so adjacent magnets have opposite magnetic orientations.

10. The apparatus of claim 2 wherein the second line includes a fourth magnet and the first and fourth magnets are arranged as a complementary pair, the fourth magnet having a magnetic orientation opposite the first magnetic orientation.

11. The apparatus of claim 2 wherein the first and second vias couple together to form a current pathway adjacent at least three sides of the second magnet.

12. The apparatus of claim 2 wherein the first via also passes the current that provides the second magnetic field.

13. The apparatus of claim 2 comprising a third via adjacent the first magnet, wherein the first and third vias couple together to form a current pathway adjacent at least three sides of the first magnet.

14. The apparatus of claim 13 wherein the first and third vias connect to one another directly beneath the first magnet.

15. The apparatus of claim 2, wherein the second magnet is between the first and third magnets and no other magnets are between the first and third magnets.

16. A magnetic wiggler comprising:
first and second magnets adjacent each other in a line of at least 50 magnets;
a pathway along which an electron beam may travel, adjacent to the line, to couple to a particle accelerator; and
a plurality of vias on multiple sides of each of the first and second magnets arranged to provide multiple currents, having opposite directions, respectively to the first and second magnets to orient the first and second magnets with opposing non-volatile orientations.

17. The apparatus of claim 16 comprising a third magnet adjacent the second magnet, wherein a distance extending from an end of the first magnet to an end of the third magnet is configured to produce a light beam with an extreme ultraviolet wavelength.

18. The apparatus of claim 17, wherein the distance is less than 500 microns.

19. A method comprising:
providing a wiggler including (a) first, second, and third magnets immediately adjacent one another in a first line, and additional magnets in a second line; (b) a pathway, between the first and second lines, along which an electron beam may travel that is arranged to couple to a particle accelerator; (c) a first via between the first and second magnets; and (d) a second via adjacent the second magnet;
passing first current to the first via and, based on the first current, providing a first magnetic field having a first orientation to the first magnet; and
passing second current to the second via and, based on the second current, providing a second magnetic field having a second orientation, opposite the first orientation, to the second magnet.

20. The method of claim 19 comprising:
programming the first magnet, with the first magnetic field, to have the first orientation; and
programming the second magnet, with the second magnetic field, to have the second orientation.

21. An apparatus comprising:
first, second, and third magnets immediately adjacent one another in a first line, and additional magnets in a second line; and
a pathway, between the first and second lines, along which an electron beam may travel that is arranged to couple to a particle accelerator;
wherein the first line of magnets (a) includes a magnet pitch distance less than 1,000 microns, and (b) is arranged with alternating magnetic orientations so adjacent magnets have opposite magnetic orientations;
wherein the first and second lines of magnets are included on a monolithic substrate.

22. The apparatus of claim 21, wherein the magnet pitch distance is less than 300 microns.

23. The apparatus of claim 21, wherein the magnet pitch distance is configured to radiate extreme ultraviolet light having a wavelength less than 300 nm.

24-25. (canceled)

26. The apparatus of claim 21, wherein the first via includes a conductive material and a horizontal axis intersects the first, second, and third magnets and the first and second vias.

27. The apparatus of claim 21, wherein (a) the first via couples a first metal layer to a second metal layer located below the first metal layer, and (b) the first via includes a perimeter completely surrounded by non-conductive material.
